(19) United States
(12) Patent Application Publication
(10) Pub. No.: US 2025/0236247 A1
(43) Pub. Date: Jul. 24, 2025

(54) BATTERY CHARGER AND ENGINE JUMP START SYSTEM WITH DUAL PORTS

(71) Applicant: Deltran Operations USA, Inc., Deland, FL (US)

(72) Inventors: Peter James Shread, Celebration, FL (US); Francisco Javier De La Cruz-Lopez, Apopka, FL (US); Michael Prelec, JR., Deland, FL (US)

(73) Assignee: Deltran Operations USA, Inc., Deland, FL (US)

(21) Appl. No.: 18/418,107

(22) Filed: Jan. 19, 2024

(51) Int. Cl. B60R 16/033; H02J 1/10; H02J 7/00; H02J 7/34; H02J 50/00; H02J 50/12; H02J 50/90

(52) U.S. Cl. CPC B60R 16/033; H02J 1/122; H02J 7/0031; H02J 7/00711; H02J 7/007182; H02J 7/342; H02J 50/005; H02J 50/12; H02J 50/90

(57) ABSTRACT

A combined battery charger and engine jump start system configured to automatically determine in which operating mode to operate based on which output port a plug is attached to is disclosed. For instance, the system may include both a battery charger subsystem and an engine jump start subsystem, whereby each includes at least one output port. The system may include a port protector enabling only one of the battery charger subsystem and the engine jump start subsystem to receive a plug at a time.

### FIELD OF THE INVENTION

The invention relates to battery chargers, and more particularly, to combined battery chargers and engine jump start systems.

### BACKGROUND

Currently, there exist dual mode battery chargers configured to charge batteries and provide boost power for engine jump start applications. These dual mode systems typically include a battery charge cable for battery charge applications and an engine jump start cable for engine jump start applications. These two cables are permanently attached to a control housing.

### SUMMARY OF THE INVENTION

A combined battery charger and engine jump start system configured to automatically determine in which operating mode to operate based on which output port a plug is attached to is disclosed. For instance, the system may include both a battery charger subsystem and an engine jump start subsystem, whereby each includes at least one output port. The system may include a port protector enabling only one of the battery charger subsystem and the engine jump start subsystem to receive a plug at a time. The combined battery charger and engine jump start system may only have plug and attached cable extending from the battery charger subsystem and the engine jump start subsystem at one time, not both, for protection of the system.

In at least one embodiment, the combined battery charger and engine jump start system may include a battery charger subsystem configured to charge a battery and an engine jump start subsystem configured to output sufficient power to jump start an engine. The system may include a battery charger port configured to releasably receive at least one output plug coupled to a battery charger cable to charge a battery. The system may also include an engine jump start port configured to releasably receive at least one output plug coupled to an engine jump start cable to jump start an engine. The system may automatically determine in which operating mode to operate based on which port is occupied by the at least one output plug.

The system may also include a port protector configured to prevent plugs from being positioned in both the battery charger port and the engine jump start port at a same time. In at least one embodiment, the port protector may enable a plug to be inserted into the battery charger port or the engine jump start port but not both ports at the same time. The port protector may include one or more covers configured to prevent plugs from being positioned in both the battery charger port and the engine jump start port at a same time. The cover may be slidably positioned on a housing of the combined battery charger and engine jump start system, whereby, in a first cover position, the at least one cover blocks the battery charger port but not the engine jump start port, and in a second cover position, the at least one cover blocks the engine jump start port but not the battery charger port.

The engine jump start subsystem may be configured to detect a presence of a battery in electrical communication with the system, determine a voltage of the system and apply a voltage to the battery to charge the battery to a target voltage. The engine jump start subsystem may be configured to apply voltage to the battery in alternating cycles of short duration jump start charge period and off period until the system determines that a target voltage of the battery has been reached.

The system may also include a safety system configured to disconnect the engine jump start subsystem from the engine jump start cable during an off mode of a jump charge. The engine jump start subsystem may be configured to provide charging power to a battery during a jump charge period and to disconnect the engine jump start subsystem from the engine jump start cable during an off period. The safety system may include one or more relays positioned inline in the engine jump start cable and configured to provide a continuous electrical connection between the engine jump start subsystem and a terminal end of the engine jump start cable during a jump charge period and to disconnect the continuous electrical connection between the engine jump start subsystem and the terminal end of the engine jump start cable during the off period. The engine jump start subsystem may include an internal battery.

The system may also include a combined input and output port. The combined input and output port may include a USB C input and output port. The system may include a combined battery charger and jump start controller configured to control operation of the battery charger subsystem and the engine jump start subsystem. The combined battery charger and jump start controller may be formed from a battery charger controller configured to control the battery charger subsystem and a jump pack controller configured to control the engine jump start subsystem.

The system may also include an AC input configured to receive AC power to provide power to the battery charger subsystem and the engine jump start subsystem. The system may also include a wireless charging system configured to charge the engine jump start subsystem.

An advantage of the system is that the system is configured to provide jump start capabilities and charge an external battery and automatically determine which mode is desired by a user.

Another advantage of the system is that the system includes a port protector that enables a plug to be inserted into the battery charger port or the engine jump start port but not both ports at the same time.

Yet another advantage of the system is that the system includes a wireless charging system configured to charge the internal battery used by the engine jump start subsystem for engine jump starts.

These and other embodiments are described in more detail below.

### BRIEF DESCRIPTION OF THE FIGURES

FIG. 1 is a perspective view of the combined battery charger and engine jump start system.

FIG. 2 is a perspective view of plugs of the battery charger cable and the jump start cable, whereby the plugs incorporate the port protector thereby enabling only a single plug to be positioned within the two ports at a single time.

FIG. 3 is a schematic diagram of the combined battery charger and engine jump start system.

FIG. 4 is a schematic diagram of another embodiment of the combined battery charger and engine jump start system including a combined battery charger and jump start controller.

FIG. 5 is a bottom view of the housing of the combined battery charger and engine jump start system, whereby the housing includes aspects of a wireless charging system.

FIG. 6 is an exploded side view of the housing of the combined battery charger and engine jump start system positioned over a charge tray of a wireless charging system.

FIG. 7 is a side view of an alternative charge tray of a wireless charging system.

FIG. 8 is a perspective view of another embodiment of the combined battery charger and engine jump start system in which a single cable is usable as a battery charge cable and as an engine jump start cable.

FIG. 9 is a perspective view of yet another embodiment of the combined battery charger and engine jump start system in which at least one of the cables is hardwired to the housing.

FIG. 10 is another perspective view of the combined battery charger and engine jump start system, whereby both the battery cable and the engine jump start cable are detachable from the housing.

FIG. 11 is a perspective view of another embodiment of the housing of the combined battery charger and engine jump start system.

FIG. 12 is a perspective view of yet another embodiment of the housing of the combined battery charger and engine jump start system.

FIG. 13 is an end view of the housing with a cover of the port protector in a second cover position covering the engine jump start port.

FIG. 14 is an end view of the housing with a cover of the port protector in a first cover position covering the battery charger port.

FIG. 15 is another perspective view of the system shown in FIG. 2 in which one of the plugs is inserted into a port.

### DETAILED DESCRIPTION OF THE FIGURES

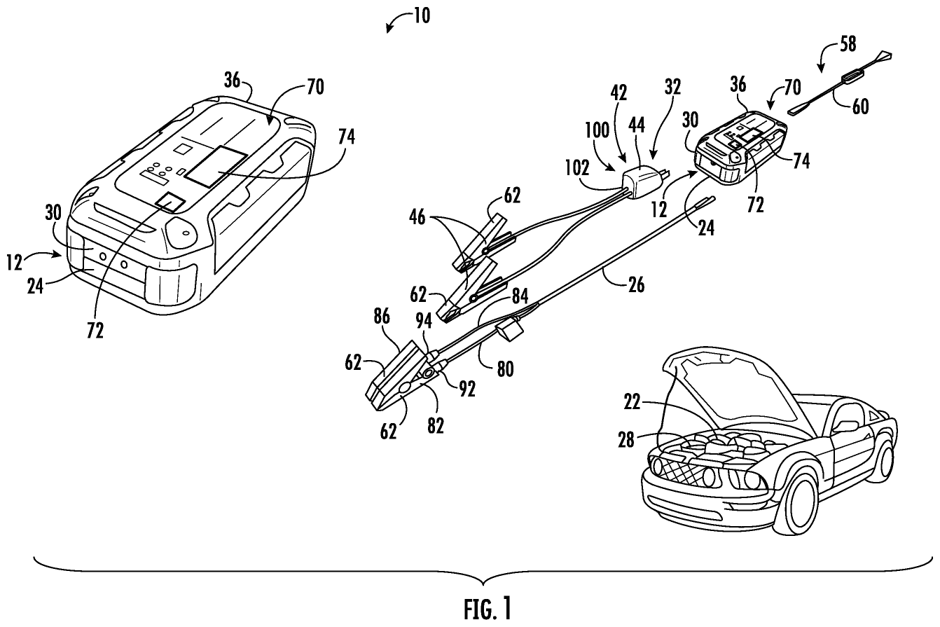

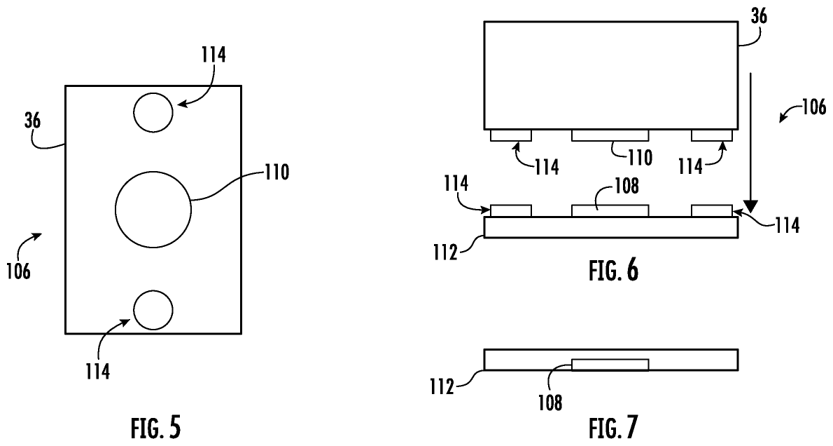

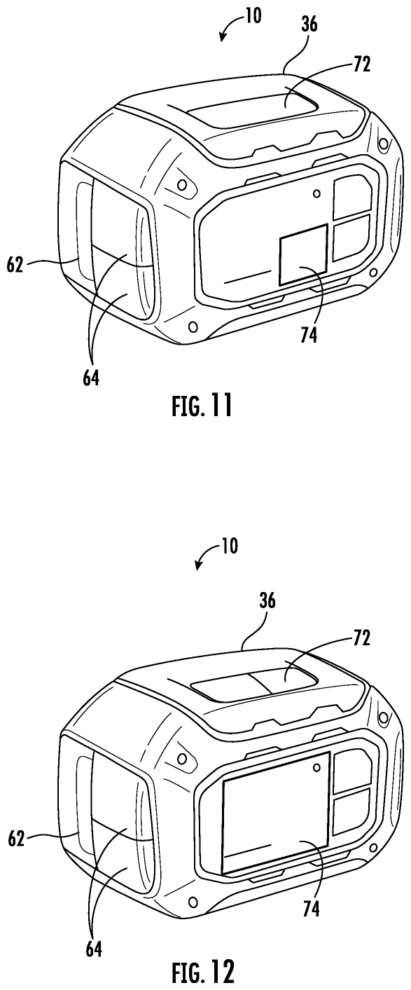

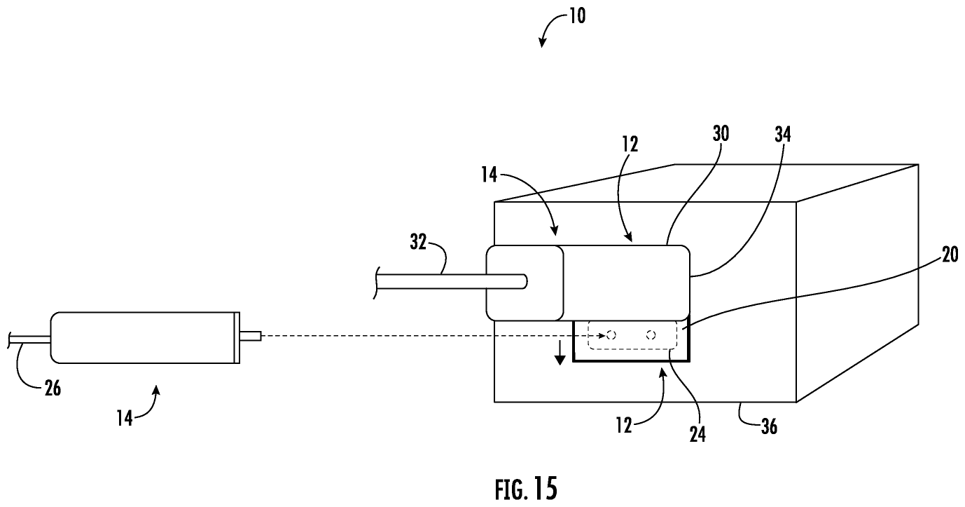

As shown in FIGS. 1-15, a combined battery charger and engine jump start system 10 configured to automatically determine in which operating mode to operate based on which output port 12 a plug 14 is attached to is disclosed. For instance, the system 10 may include both a battery charger subsystem 16 and an engine jump start subsystem 18, whereby each includes at least one output port 12. The system 10 may include a port protector 20 enabling only one of the battery charger subsystem 16 and the engine jump start subsystem 18 to receive a plug 14 at a time. The combined battery charger and engine jump start system 10 may only have plug 14 and attached cable 21, as shown in FIG. 15, extending from the battery charger subsystem 16 and the engine jump start subsystem 18 at one time, not both, for protection of the system 10.

In at least one embodiment, the combined battery charger and engine jump start system 10 may include a battery charger subsystem 16 configured to charge a battery and an engine jump start subsystem 18 configured to output sufficient power to jump start an engine 22. The system 10 may include a battery charger port 24 configured to releasably receive one or more output plugs 14 coupled to a battery charger cable 26 to charge a battery 28. The external battery 28 may be charged in any appropriate manner, and in at least one embodiment, may be, but is not limited to being, charged with an alternating current (AC) charging input or a direct current (DC) charging input. The charging port may have any appropriate configuration, and in at least one embodiment, may be a Type C input port.

The combined battery charger and engine jump start system 10 may include an engine jump start port 30 configured to releasably receive one or more output plugs 14 coupled to an engine jump start cable 32 to jump start an engine 22. The system 10 may be configured to automatically determine in which operating mode to operate based on which port 12 is occupied by the output plug 14. In particular, the system 10 may sense in which port 12 an output plug 14 is inserted and active the corresponding subsystem 16 or 18. In at least one embodiment, the system 10 may include at least one way of manually setting the system 10 in a charge mode or a jump start mode. The system 10 may enable a user to choose which mode to operate in via a button, input option on a graphical user interface or other input device.

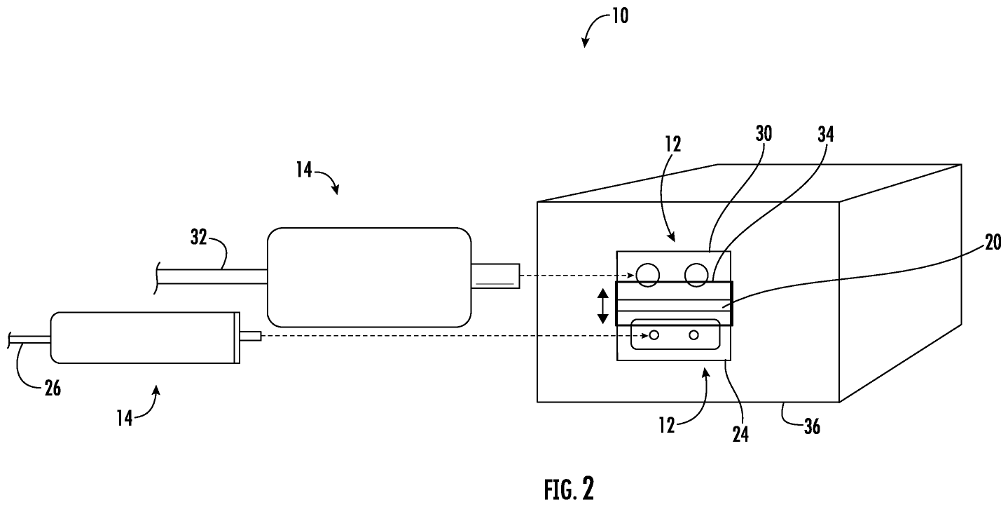

The system 10 may also include a port protector 20, as shown in FIGS. 2, 13 and 14, configured to prevent plugs 14 from being positioned in both the battery charger port 24 and the engine jump start port 30 at a same time. Thus, the port protector 20 may enable a plug 14 to be inserted into the battery charger port 24 or the engine jump start port 30 but not both ports at the same time. In at least one embodiment, the port protector 20 may be, but it not limited to being, a configuration of the plug 14 being such that when plug 14 is plugged into the battery charger port 24, another plug 14 cannot be plugged into the engine jump start port 30 because the plug 14 in the battery charger port 24 physically interferes with another plug 14 to prevent the plug 14 from being inserted into the engine jump start port 30. Similarly, the port protector 20 may be, but it not limited to being, a configuration of the plug 14 being such that when plug 14 is plugged into the engine jump start port 30, another plug 14 cannot be plugged into the battery charger port 24 because the plug 14 in the engine jump start port 30 physically interferes with another plug 14, as shown in FIG. 2, to prevent the plug 14 from being inserted into the battery charger port 24.

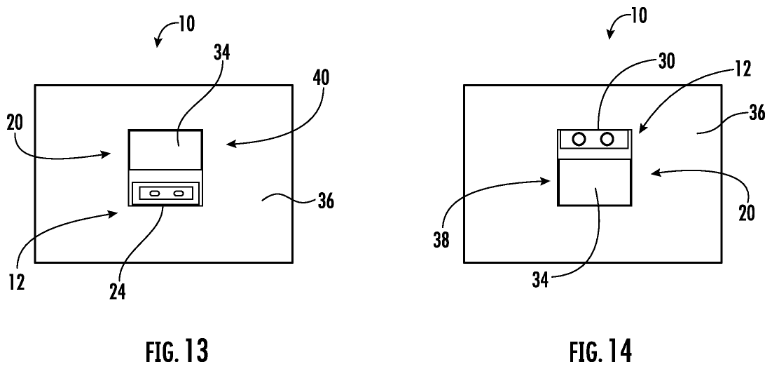

In at least one embodiment, the port protector 20 may include one or more covers 34, as shown in FIGS. 13 and 14, configured to prevent plugs 14 from being positioned in both the battery charger port 24 and the engine jump start port 30 at a same time. The cover 34 may be slidably positioned on a housing 36 of the combined battery charger and engine jump start system 10. The cover 34, in a first cover position 38, as shown in FIG. 14, may block the battery charger port 24 but not the engine jump start port 30, and in a second cover position 40, as shown in FIG. 13, may block the engine jump start port 30 but not the battery charger port 24.

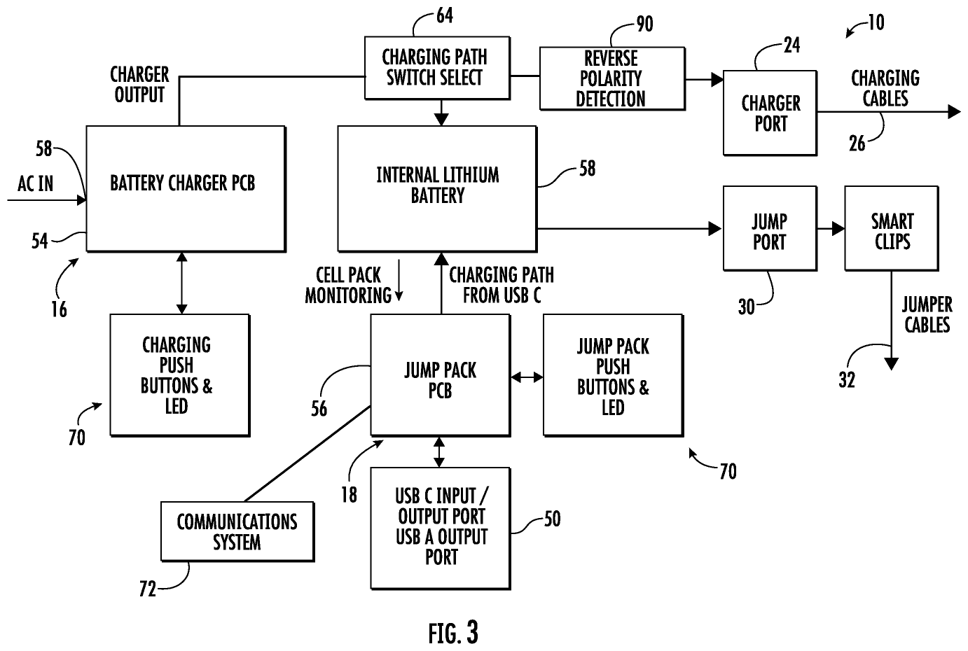

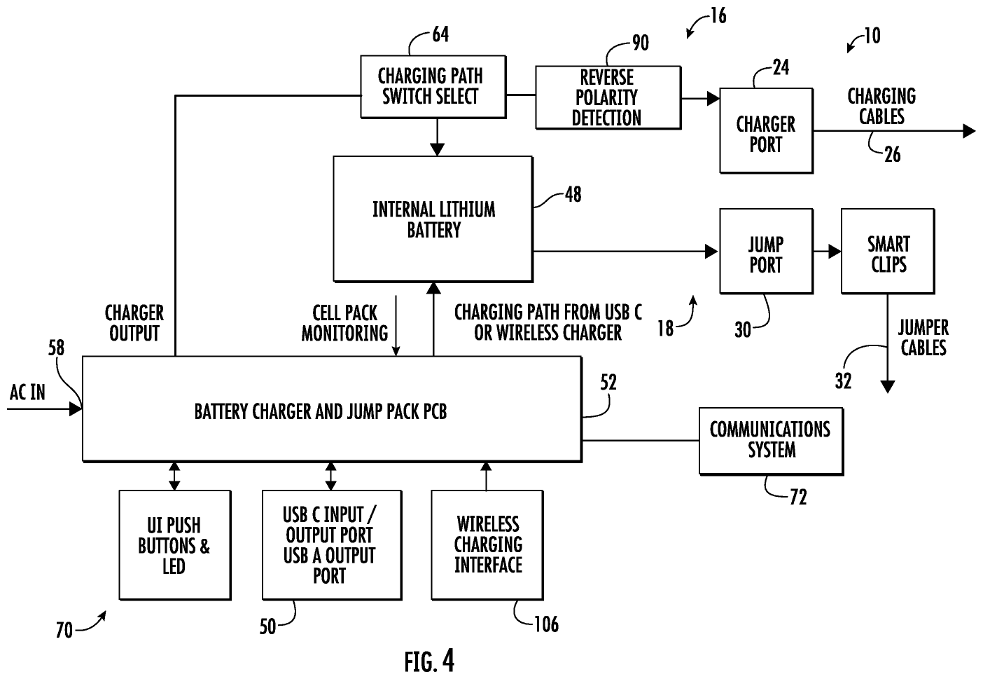

The engine jump start subsystem 18, as shown in FIGS. 3 and 4, may be configured to detect a presence of a battery 28 in electrical communication with the system 10, determine a voltage of the system 10 and apply a voltage to the battery 28 to charge the battery 28 to a target voltage. The engine jump start subsystem 18 may be configured to apply voltage to the battery 28 in short jump charge periods separated by off periods with an open path until the system 10 determines that a target voltage of the battery 28 has been reached. The system 10 may also include a safety system 42 configured to disconnect the engine jump start subsystem 18 from the engine jump start cable 32 during an off mode of a jump charge. The engine jump start subsystem 18 may be configured to provide jump charge to a battery 28 during a short jump charge period and to disconnect the engine jump start subsystem 18 from the engine jump start cable 32 during an off period once the short duration jump charge stops. If the battery voltage is less than a threshold minimum voltage, then another short jump charge period is applied. If the battery voltage is greater than a threshold minimum voltage, then the desired battery voltage has been obtained and the process ceases. If the number of jump attempts is greater than an established maximum jump attempts count, then the engine jump start subsystem 18 identifies an error condition existing. The safety system 42 may include one or more relays 44 positioned inline in the engine jump start cable 32 and configured to provide a continuous electrical connection between the engine jump start subsystem 18 and a terminal end 46 of the engine jump start cable 32 during a short jump charge period and to disconnect the continuous electrical connection between the engine jump start subsystem 18 and the terminal end 46 of the engine jump start cable 32 during an off period once the short duration jump charge stops.

The engine jump start subsystem 18 of the system 10 may include one or more internal batteries 48. The internal battery 48 may be formed from any appropriate battery chemistry, such as, but not limited to, a lithium battery, a lead acid battery, an AGM battery and a gel battery. The internal battery 48 may be configured and sized to provide sufficient cranking power to complete an engine jump start. In at least one embodiment, the internal battery 48 may be sized to fit within the housing 36 of the combined battery charger and engine jump start system 10. Conversely, the housing 36 may be sized to accommodate the internal battery 48. The internal battery 48 may be charged in any appropriate manner, and in at least one embodiment, may be, but is not limited to being, charged with a direct current (DC) charging input. The internal battery 48 may also be charged with alternating current (AC) charging input. The AC charging input may be an AC/DC power supply configured to receive AC power. The charging port may have any appropriate configuration, and in at least one embodiment, may be a Type C input port.

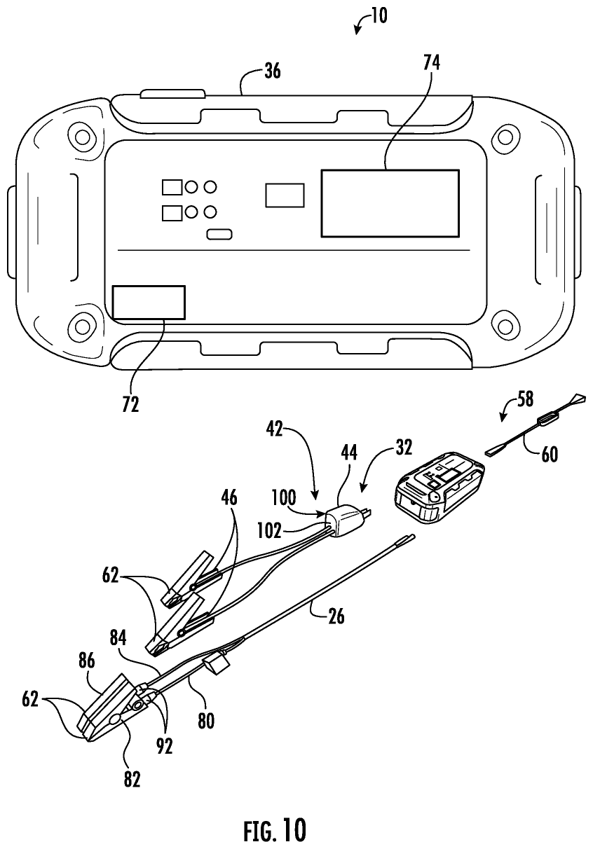

The housing 36 may have different configurations as shown in FIGS. 10-12. The housing 36 may include one or more accessory lights 62 configured to enable a user to work safely at night. The housing 36 may include one or more covers 64 to cover the ports 24 and 30 when not in use.

The system 10 may include a combined input and output port 50. The combined input and output port 50 may be configured into any appropriate connector. In at least one embodiment, the combined input and output port 50 may be a USB C input and output port or other configured port. The combined input and output port 50 may receive alternating current (AC), direct current (DC) or other type power. The combined input and output port 50 may be used to charge the internal battery 48 or the external battery 28, or both.

The system 10 may include a combined battery charger and jump start controller 52, as shown in FIG. 4, configured to control operation of the battery charger subsystem 16 and the engine jump start subsystem 18. The combined battery charger and jump start controller 52 may be formed from a battery charger controller 54 configured to control the battery charger subsystem 16 and a jump pack controller 56 configured to control the engine jump start subsystem 18. The battery charger controller 54 may be formed from a battery charger PCB configured to control the battery charger subsystem 16. The jump pack controller 56 may be formed from a jump pack PCB configured to control the engine jump start subsystem 18. The jump pack controller 56 may be configured to conduct cell pack monitoring of the internal battery 48 in the combined battery charger and engine jump start system 10. The battery charger controller 54 may also be configured to conduct cell pack monitoring of the internal battery 48 in the combined battery charger and engine jump start system 10.

The system 10 may include an AC input 58, as shown in FIGS. 3 and 4, configured to receive AC power to provide power to the battery charger subsystem 16 and the engine jump start subsystem 18. The AC input 58 may be an AC/DC power supply configured to receive AC power, such as, but not limited to AC power between 5 volts AC and 240 volts AC, and convert that power to DC power, such as, but not limited to 12 volts DC. In other embodiments, the AC/DC power supply may be configured to receive AC power partially outside of this voltage range or completely outside of this voltage range. The AC/DC power supply may be configured to receive but not limited AC line frequency of 47 hertz (Hz) to 63 Hz.

A charging cable 60, as shown in FIG. 10, may be permanently or removably attached to the system 10. In at least one embodiment, the charging cable 60 may include a conventional two prong electrical plug configured to be coupled to receptacle in electrical communication with a power supply, such as, but not limited to, a municipal power supply. The charging cable 60 may include a Type C connector or other appropriate connector to be attached to the system 10.

The system 10 may include an input system 70 configured to enable a user to provide input to the battery charger controller 54. The input system 70 may enable a user to control the battery charger controller 54 or the battery charger subsystem 16, or both. The input system 70 may include one or more lights, such as, but not limited to light emitting diodes (LEDs) configured to indicate various aspects of the system 10, such as, but not limited to, charge of internal battery 48, charge of external battery 28, current and voltage output selection, battery chemistry selection, operational mode between battery charging with the battery charger subsystem 16 and engine jump start with the engine jump start subsystem 18, reverse polarity of the clips 62, power on/off, status of the engine jump start subsystem 18 indicating waiting for battery, jumping, success or failure, and other diagnostic information. The input system 70 may include one or more graphical user interfaces 74 enabling a user to control the system 10, including the battery charger subsystem 16 and the engine jump start subsystem 18. In at least one embodiment, the graphical user interface 74 may be a liquid crystal display (LCD).

The system 10 may further include a communications system 72 to enable a user to communicate remotely with the battery charger controller 54. The communications system 72 may enable a user to communicate remotely with the battery charger controller 54 via wired or wireless systems, including, but not limited to, the internet, an application (app), Bluetooth, WiFi, and the like.

The battery charger cable 26 may include one or more positive cables 80 with a terminal connector 82, which may be, but is not limited to being, a releasable connector, such as an alligator clip and one or more negative cables 84 with a terminal connector 86, which may be, but is not limited to being, a releasable connector, such as an alligator clip.

In another embodiment, the battery charger port 24 and the engine jump start port 30 may differ in physical configuration preventing a battery charger cable 26 from being attached to the engine jump start port 30 and preventing an engine jump start cable 32 from being attached to the battery charger outlet port 24.

The system 10 may include a reverse polarity detection system 90, as shown in FIGS. 3 and 4, configured to sense when terminal ends 92, 46 of the battery charger cable 26 and the engine jump start cable 32 are connected to the wrong posts on a battery 28. The reverse polarity detection system 90 alerts a user to the battery charger cable 26 and the engine jump start cable 32 are connected to the wrong posts on a battery 28 to prevent damage to the system 10 or the battery 28, or both.

The system 10 may a circuit protection system 100, as shown in FIGS. 1, 9 and 10, to prevent short circuits. In particular, the circuit protection system 100 may prevent power from being provided to terminal ends 46 of the engine jump start cable 32 when the engine jump start cable 32 is not coupled to a battery 28. In at least one embodiment, the circuit protection system 100 may include one or more relays 102 connecting clips to internal cell pack 48.

The system 10 may be configured in different combinations of output for the battery charger subsystem 16 and the engine jump start subsystem 18 in systems such as, but not limited to 12 volt-nominal systems. In particular, the system 10 may include a battery charger subsystem 16 configured to output from between 4 amps and 25 amps. The engine jump start subsystem 18 may be configured to output from between 1,000 amps and 2,000 amps. The system 10 may include output combinations of the battery charger subsystem 16 and the engine jump start subsystem 18 including, but not limited to, a 4 amp output battery charger subsystem 16 and a 1,000 amp output engine jump start subsystem 18; a 15 amp output battery charger subsystem 16 and a 1,500 amp output engine jump start subsystem 18; and a 25 amp output battery charger subsystem 16 and a 2,000 amp output engine jump start subsystem 18. In at least one embodiment, the battery charger subsystem 16 may operate in 12 volts-nominal only.

The battery charger subsystem 16 may be configured to operate with a variety of different battery types, including, but not limited to, a lithium battery, a lead acid battery, an absorbed glass mat (AGM) battery and a gel battery. The battery charger subsystem 16 may be configured to automatically determine battery chemistry upon being attached to a battery 28. The battery charger subsystem 16 may be a manual selector enabling a user to choose which battery type mode for operation of the battery charger subsystem 16.

The battery charger subsystem 16 may be configured to perform battery level detection for safe jump starting procedures. In at least one embodiment, the battery charger subsystem 16 may be configured to perform an alternator check of an alternator in communication with an external battery 28 to determine if the alternator is producing a charging current when a motor to which the alternator is mounted is running. In at least one embodiment, the battery charger subsystem 16 may be configured to perform a check of a charging system in communication with an external battery 28 to determine if the alternator is producing a charging current.

The system 10 may include a wireless charging system 106 configured to charge the internal battery 48 of the engine jump start subsystem 18. The wireless charging system 106 may be configured to charge through induction, resonance, electro-magnetic radiation or other methods. In at least one embodiment, the wireless charging system 106 may charge the internal battery 48 via electromagnetic induction or other technology. In at least one embodiment in which electromagnetic induction is incorporated, the wireless charging system 106 may employ the Qi or Qi2 wireless charging standards or other charging standards. In at least one embodiment, the wireless charging system 106 may include a wireless receiver 110 positioned near a bottom of the housing 36. The housing 36 may be configured to mate with a charge tray 112 configured to receive the housing 36 and allow charging or maintenance charging, or both, of the internal battery 48. The tray 112 may include a wireless transmitter 108 configured to be aligned with the wireless receiver 110 in the battery housing 36. The wireless charging system 106 may include an alignment system 114 configured to align the internal battery 48 in the housing 36 with the charge tray 112 to enable the wireless charging system 106 to charge the internal battery 48 by placing the wireless transmitter 108 in close physical proximity to the wireless receiver 110. The alignment system 114 may include magnets, mechanical guides or other components to align the housing 36 with the charge tray 112.

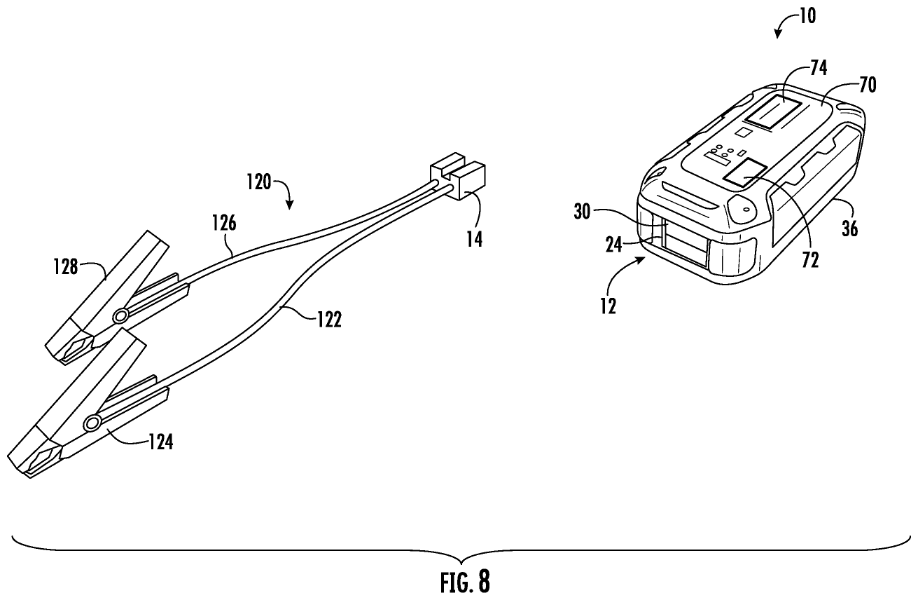

In at least one embodiment, as shown in FIG. 8, the combined battery charger and engine jump start system 10 may include a combined battery charger and jump start cable 120. The battery charger port 24 and the engine jump start port 30 may have the same configuration enabling a plug 14 on the combined battery charger and jump start cable 120 to be inserted into either the battery charger port 24 or the engine jump start port 30. In at least one embodiment, the combined battery charger and jump start cable 120 may be formed from a positive cable 122 with a terminal connector 124, which may be, but is not limited to being, a releasable connector, such as an alligator clip, and one or more negative cables 126 with a terminal connector 128, which may be, but is not limited to being, a releasable connector, such as an alligator clip. In at least one embodiment, the combined battery charger and jump start cable 120 may have a somewhat short length of less than one foot long formed from a large gage wire, such as, but not limited to 10 or 8 American wire gauge (AWG). In this embodiment, components enabling smart clip function may be included within the housing 36. This embodiment may include the other components and functionality described in this application, such as, but not limited to, the port protector 20 and other components, but are not disclosed here so as to not be redundant.

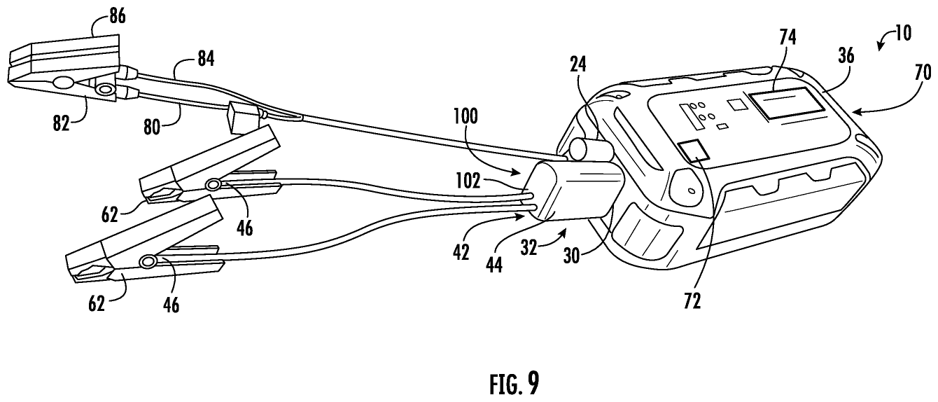

In at least one embodiment, as shown in FIG. 9, the combined battery charger and engine jump start system 10 may include a battery charger cable 26 hardwired to the battery charger subsystem 16 within the housing 36. The combined battery charger and engine jump start system 10 may also include an engine jump start cable 32 hardwired to the engine jump start subsystem 18 within the housing 36. In at least one embodiment, the combined battery charger and engine jump start system 10 may have a battery charger cable 26 hardwired to the battery charger subsystem 16, and the engine jump start cable 32 may be releasably attachable to an engine jump start port 30. Similarly, in another embodiment, the engine jump start cable 32 may be hardwired to the engine jump start subsystem 18 within the housing 36, and the battery charger cable 26 releasably attachable to the battery charger port 24. The combined battery charger and engine jump start system 10 may be configured such that if a cable is not attached to the engine jump start port 30 or the battery charger port 24, then the system 10 will automatically operate with the cable 26 or 32 that is hardwired to the housing 36. Otherwise, if the removable cable 26 or 32 is attached to the port 24 or 30, then the system 10 will automatically operate in the mode and subsystem 16 or 18 that is coupled with that port 24 or 30, respectively. Alternatively, the system 10 may be configured to automatically operate in the mode and subsystems 16 or 18 depending on up which port 24 or 30 is in electrical communication with an external battery. In other words, if the system 10 detects an external battery 28 on the engine jump start port 30, then the engine jump start subsystem 18 jumps the external battery 28. If the system 10 detects an external battery 28 on the charge battery charger port 28, then the battery charger subsystem 16 charges the external battery 28.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A combined battery charger and engine jump start system, comprising:
a battery charger subsystem configured to charge a battery;
an engine jump start subsystem configured to output sufficient power to jump start an engine;
a battery charger port configured to releasably receive at least one output plug coupled to a battery charger cable to charge a battery;
an engine jump start port configured to releasably receive at least one output plug coupled to an engine jump start cable to jump start an engine;
wherein the system automatically determines in which operating mode to operate based on which port is occupied by the at least one output plug.

2. The combined battery charger and engine jump start system of claim 1, further comprising a port protector configured to prevent plugs from being positioned in both the battery charger port and the engine jump start port at a same time.

3. The combined battery charger and engine jump start system of claim 2, wherein the port protector comprises at least one cover configured to prevent plugs from being positioned in both the battery charger port and the engine jump start port at a same time.

4. The combined battery charger and engine jump start system of claim 3, wherein the at least one cover is slidably positioned on a housing of the combined battery charger and engine jump start system, whereby, in a first cover position, the at least one cover blocks the battery charger port but not the engine jump start port, and in a second cover position, the at least one cover blocks the engine jump start port but not the battery charger port.

5. The combined battery charger and engine jump start system of claim 1, wherein the engine jump start subsystem is configured to detect a presence of a battery in electrical communication with the system, determine a voltage of the system and apply a voltage to the battery to charge the battery to a target voltage.

6. The combined battery charger and engine jump start system of claim 5, wherein the engine jump start subsystem is configured to apply voltage to the battery in alternating cycles of short duration jump start charge period and off period until the system determines that a target voltage of the battery has been reached.

7. The combined battery charger and engine jump start system of claim 6, further comprising a safety system configured to disconnect the engine jump start subsystem from the engine jump start cable during an off period.

8. The combined battery charger and engine jump start system of claim 7, wherein the safety system comprises at least one relay positioned inline in the engine jump start cable and configured to provide a continuous electrical connection between the engine jump start subsystem and a terminal end of the engine jump start cable during a short jump charge period and to disconnect the continuous electrical connection between the engine jump start subsystem and the terminal end of the engine jump start cable during an off period.

9. The combined battery charger and engine jump start system of claim 1, wherein the engine jump start subsystem further comprises an internal battery.

10. The combined battery charger and engine jump start system of claim 1, further comprising a combined input and output port.

11. The combined battery charger and engine jump start system of claim 10, wherein the combined input and output port comprises a USB C input and output port.

12. The combined battery charger and engine jump start system of claim 1, further comprising a combined battery charger and jump start controller configured to control operation of the battery charger subsystem and the engine jump start subsystem.

13. The combined battery charger and engine jump start system of claim 1, wherein the combined battery charger and jump start controller is formed from a battery charger controller configured to control the battery charger subsystem and a jump pack controller configured to control the engine jump start subsystem.

14. The combined battery charger and engine jump start system of claim 1, further comprising an AC input configured to receive AC power to provide power to the battery charger subsystem and the engine jump start subsystem.

15. The combined battery charger and engine jump start system of claim 1, further comprising a wireless charging system configured to charge the engine jump start subsystem.

16. The combined battery charger and engine jump start system of claim 1, further comprising a combined battery charger and jump start cable configured to be inserted into both the battery charger port and the engine jump start port at different times.

17. A combined battery charger and engine jump start system, comprising:
a battery charger subsystem configured to charge a battery;
an engine jump start subsystem configured to output sufficient power to jump start an engine, wherein the engine jump start subsystem comprises at least one internal battery;
a battery charger port configured to releasably receive at least one output plug coupled to a battery charger cable to charge a battery;
an engine jump start port configured to releasably receive at least one output plug coupled to an engine jump start cable to jump start an engine;
wherein the system automatically determines in which operating mode to operate based on which port is occupied by the at least one output plug;
a port protector configured to prevent plugs from being positioned in both the battery charger port and the engine jump start port at a same time.

18. The combined battery charger and engine jump start system of claim 17, wherein the port protector comprises at least one cover configured to prevent plugs from being positioned in both the battery charger port and the engine jump start port at a same time.

19. The combined battery charger and engine jump start system of claim 18, wherein the at least one cover is slidably positioned on a housing of the combined battery charger and engine jump start system, whereby, in a first cover position, the at least one cover blocks the battery charger port but not the engine jump start port, and in a second cover position, the at least one cover blocks the engine jump start port but not the battery charger port.

20. A combined battery charger and engine jump start system, comprising:
a battery charger subsystem configured to charge a battery;
an engine jump start subsystem configured to output sufficient power to jump start an engine, wherein the engine jump start subsystem comprises at least one internal battery;
a battery charger port configured to releasably receive at least one output plug coupled to a battery charger cable to charge a battery;
an engine jump start port configured to releasably receive at least one output plug coupled to an engine jump start cable to jump start an engine;
a port protector configured to prevent plugs from being positioned in both the battery charger port and the engine jump start port at a same time.

21. The combined battery charger and engine jump start system of claim 19, wherein the port protector comprises at least one cover configured to prevent plugs from being positioned in both the battery charger port and the engine jump start port at a same time.
